(19) United States
(12) Patent Application Publication
(10) Pub. No.: US 2011/0205342 A1
(43) Pub. Date: Aug. 25, 2011

(54) ELECTRICALLY-DRIVEN LIQUID CRYSTAL LENS AND STEREOSCOPIC DISPLAY USING THE SAME

(75) Inventors: Jyun-Cheng Lin, Zhongli City (TW); Sheng-chi Liu, Xindian City (TW); Long-cai Jhuo, Banqiao City (TW)

(73) Assignee: CHUNGHWA PICTURE TUBES, LTD.,, Bade City (TW)

(21) Appl. No.: 12/776,383

(22) Filed: May 8, 2010

(30) Foreign Application Priority Data
Feb. 24, 2010 (TW) 099105375

(51) Int. Cl. H04N 13/04; G02F 1/13

(52) U.S. Cl. 348/54; 349/200; 348/E13.075

(57) ABSTRACT

An electrically-driven liquid crystal lens is disclosed. The electrically-driven liquid crystal lens being partitioned into a lens region and a non-lens region includes: a first and a second substrates disposed opposite to each other; a protrusion formed on the first substrate corresponding to the lens region, a first electrode formed on the first substrate and the protrusion for guiding electrical fields to increase the focus of the lens, and a second electrode formed on the non-lens region of the second substrate; a liquid crystal layer provided between the first electrode and the second electrode. A stereoscopic display using the electrically-driven liquid crystal lens is also disclosed.

### TECHNICAL FIELD OF THE INVENTION

The present invention generally relates to a liquid crystal lens, and more particularly to an electrically-driven liquid crystal lens and a stereoscopic display using the same.

### BACKGROUND OF THE INVENTION

Nowadays, stereoscopic display technology is acknowledged as the most important research and development trend after high-definition technology in the display field. Human eyes can see a three-dimensional (3D) image according to stereo-vision concept, that is, the 3D image is formed when human eyes are separated by a distance of about 65 mm, thereby causing a binocular disparity. When the left eye and the right eye respectively see two different two-dimensional (2D) images being sent to the human brain via retinas, the two different 2D images are fused as an impression of a real 3D image and perceived by the human brain.

Accordingly, to display a 3D image via a flat-panel display, it requires providing two sets of interlaced images on the same frame so as to simulate stereoscopic vision of human eyes, and enabling the two eyes to receive the two sets of images respectively via polarization glasses or an optical grating to achieve the effect of stereoscopic vision. However, using polarization glasses in some circumstances may be inconvenient. Therefore, a number of different designs for the naked-eye stereoscopic displays have been developed to directly project the two sets of images to the left eye and the right eye through optical designs.

Usually, the naked-eye stereoscopic display utilizes two kinds of techniques to achieve the effect of stereoscopic visions, one of the techniques uses a parallax barrier (Barrier), and the other uses a lenticular array (Lenticular). In fact, the concepts of these two techniques are similar. In both techniques, the pixels of a liquid crystal display (LCD) are utilized to display two different set of images for the left and right eyes, and the left eye sees the pixels of the left eye images and the right eye sees the pixels of right eye images through the parallax barrier or the lenticular array.

Please refer to FIG. 1. FIG. 1 is a schematic diagram illustrating a conventional stereoscopic display technique using a parallax barrier. The parallax barrier 110 blocks a part of the light from the display panel 100. Through the parallax barrier 110, the observer 150 is capable of viewing the pixels of the left eye images 101 with the left eye and viewing the pixels of the right eye images 102 with the right eye.

Please refer to FIG. 2. FIG. 2 is a schematic diagram illustrating a conventional stereoscopic display technique using a lenticular array. The lights from the pixels of left eye images 101 and the pixels of right eye images 102 are respectively refracted to the left eye and the right eye of the observer 150 via the lenticular array 120.

However, when the pixels of the LCD panel are divided into several groups by the parallax barrier (Barrier), the resolution is reduced, the screen particles become enlarged, and in addition, the brightness is reduced. Although the lenticular array will not cause the reduction of the brightness, the lenticular array needs to be made into the scale of a pixel size with high precision, and therefore micro manufacturing processes are needed. As a result, the cost is increased. Furthermore, another problem of the lenticular array technique is that a display using said technique can not be served as a traditional flat panel display to display 2D images in some circumstances (e.g. executing the word processing tasks), in which stereoscopic displaying is unnecessary.

Currently, in the techniques of achieving the naked-eye 3D display, a liquid crystal lens (LC lens) has been introduced to replace the techniques of the parallax barrier or the lenticular array. The LC lens is a liquid crystal layer with the characteristics of lens. The LC lens utilizes the characteristics of the birefringence of the liquid crystal molecules and the liquid crystal molecules being rotated by an electric field. With controlling the rotation of the liquid crystal molecules by means of an electric field, the liquid crystal layer shows a gradient distribution of refractive indices such as a gradient-index (GRIN) lens resulting in the deflection of light paths for achieving the focus effect.

FIG. 3a is a schematic cross-sectional diagram illustrating a conventional LC lens with an off-load voltage. FIG. 3b is a graph illustrating a relationship between the refractive indices and the positions of the LC lens with an off-load voltage. As shown in FIG. 3a, a conventional LC lens includes a first substrate 11 and a second substrate 12 being parallel to each other, and a liquid crystal layer 13 formed between the first substrate 11 and the second substrate 12. There is a first electrode 10 formed on the inward surface of the first substrate 11, and a second electrode pattern 20 formed on the inward surface of the second substrate 12. The liquid crystal molecules 30 of the liquid crystal layer 13 are nematic liquid crystals, wherein the nematic liquid crystals are a single optical axis (Uniaxial) medium, and the optical axis is parallel to guide axis 31 of the liquid crystal molecules 30. When the electric field of a light is perpendicular to the optical axis, the refractive index of the light sensing is nₒ, i.e. called “ordinary index”. When the electric field of a light is parallel to the optical axis, the refractive index of the light sensing is nₑ, i.e. “extraordinary index”.

Please refer to FIG. 3a, while voltage difference is not applied to the first electrode 10 and second electrode 20, the electric field is not generated within the liquid crystal layer 13, and meanwhile the guide axes 31 of the liquid crystal molecules 30 is along the alignment layer (not shown in the figure) and parallel to the first substrate 11 and the second substrate 12. Please refer to FIG. 3b. Meanwhile, the incident light 50 senses the refractive indices does not change with different incident positions, and the refractive indices are an extraordinary index nₑ. Accordingly, the incident light 50 are perpendicular to the substrate, and there is no focus effect therebetween.

FIG. 4a is a schematic cross-sectional diagram illustrating a conventional LC lens with an on-load voltage. FIG. 4b is a graph illustrating a relationship between the refractive indices and the positions of the LC lens with an on-load voltage. Please refer to FIG. 4a, while voltage difference is applied to the first electrode 10 and second electrode 20, the edge of the second electrode pattern 20 generates non-uniform electric fields 56. That is, the guide axes 31 of the liquid crystal molecules 30 are rotated by the electric fields 56 due to fringing fields 55 generated at the edge of the lens region. While the light is a normal incidence, the refractive indices of the incident lights 50 change with different incident positions. The central region of the LC lens within the liquid crystal layer 13 is scarcely affected by the fringing fields 55. The guide axes 31 of the liquid crystal molecules herein are parallel to the substrate. The refractive indices within the central region, which the incident light 50 senses, remains an extraordinary index ne. In the region away from the LC lens, the electric fields 56 are perpendicular to the substrate, and the orientations of the guide axes 31 of the liquid crystal molecules 30 are perpendicular to the substrate. The refractive indices, which the incident lights 50 that are away from LC lens sense, are an extraordinary index no. Please refer to FIG. 4b. Due to the effect of the fringing fields 55, the refractive indices of the incidence light 50 within lens region generate a gradient change with the incidence positions so that a focus effect of the normal incident lights 50 appear in this lens region.

However, the first electrode 10 and the second electrode 20 are formed on the inward surface of the first substrate 11 and the second substrate 12, so the effect of the fringing fields is not strong. Further, the guide axes 31 of the liquid crystal molecules 30 within the region of the LC lens can not be rotated in large angles so that the focus effect is not good.

Therefore, an improved solution is provided as follows. FIG. 5a is a schematic cross-sectional diagram illustrating an improved conventional LC lens with an on-load voltage. FIG. 5b is a graph illustrating a relationship between the refractive indices of incident lights and the positions of the improved LC lens with an on-load voltage. Please refer to FIG. 5a, the improved method is such that the first electrode 10 and the second electrode 20 are formed on the outer surface of the first substrate 11 and the second substrate 12. Due to the distance is increased between the first electrode 10 and the second electrode 20, the effect of the fringing fields is increased, and the orientations of the electric field 56 in the edge of the lens region are made sharper, and thus making the focus effect better. Please refer to FIG. 5b, the refractive indices of the incidence light 50 within lens region generate a gradient change with the incidence positions, and that change is more obvious for producing a better light focus effect.

However, due to the distance is increased between the first electrode 10 and the second electrode 20, resulting in the electrically-driven liquid crystal lens 30 to be as high as 150V or so, which increases the cost of making the driving components of the liquid crystal lens, and this also increases power consumption. In addition, while the liquid crystal lens is applied to a zoom lens or a large-scale stereoscopic display, the central region of the liquid crystal lens is further away from the electrode edge. The liquid crystal molecules that are near the central region are substantially free from the effect of the fringing fields. Therefore, the liquid crystal molecules that are near the central region are rotated insufficiently results in the deformation of the shape of the lens, and the focus effect is greatly reduced causing ineffective 3D images.

For this reason, there is an urgency to provide an efficient liquid crystal lens with low power consumption to resolve the above-mentioned problems and issues.

### SUMMARY OF THE INVENTION

Accordingly, an object of the present invention is to provide an electrically-driven liquid crystal lens, which has a special design of electrode, thereby reducing the driving voltage and power consumption.

Another object of the present invention is to provide a stereoscopic display using the electrically-driven liquid crystal lens of the present invention, which has the capability of switching between 3D images and 2D images, and to reduce the driving voltage and power consumption of the electrically-driven liquid crystal lens, and to improve 3D image quality.

To achieve the foregoing and the other objects, and advantages and accordance with the purpose of the invention, as embodied and broadly described herein, an electrically-driven liquid crystal lens, which is partitioned into a lens region and a non-lens region, includes a first substrate, a second substrate, a protrusion, a first electrode, a second electrode, a liquid crystal layer and a voltage source.

The second substrate is disposed parallel to the first substrate and is separated from the first substrate by a predetermined interval. The protrusion is formed on the first substrate, wherein the position of the protrusion corresponds to the lens region. The first electrode is formed over the inward surface of the first substrate and covers the protrusion. The second electrode is formed on the surface of the second substrate, which is located in the non-lens region. The liquid crystal layer is provided between the first and the second substrates. The voltage source is electrically coupled to the first and the second electrodes, wherein the voltage source respectively applies voltages to the first and the second electrodes for driving liquid crystal molecules to rotate.

In one preferred embodiment of the present invention, the second electrode is formed on the inward surface of the second substrate. The protrusion has a thickness thereof, furthermore; the cross-sectional diagram of the protrusion is a symmetrical or asymmetrical shape. The height and width of the symmetrical or asymmetrical shape are between 2 μm to 20 μm, wherein the symmetrical or asymmetrical shape is a geometrical shape such as triangle, trapezoid, semicircle or bell.

The electrically-driven liquid crystal lens according to an embodiment of the present invention, further includes: a first alignment film formed over the entire surface of the first electrode for aligning liquid crystal molecules to be parallel to the surface of the first substrate; and a second alignment film formed over the entire surface of the second electrode and the second substrate for aligning liquid crystal molecules to be parallel to the surface of the second substrate. In one preferred embodiment, the first electrode and the second electrode are composed of transparent conductively materials.

According to the electrically-driven liquid crystal lens of the present invention, the shapes of the protrusion induce the fringing fields for guiding the liquid crystal molecules that are near the central region of the lens region to rotate sufficiently. Therefore, the second electrode can be disposed on the inward surface of the second substrate, and such configuration can significantly reduce the driving voltage, and the focus effect is greatly increased.

In addition, the present invention further provides a stereoscopic display, which includes a layer of electrically-driven liquid crystal lens and a display panel. The layer of electrically-driven liquid crystal lens partitioned into a plurality of lens regions and at least one non-lens region, wherein the lens regions and the non-lens regions interlace with one another, includes: a first substrate and a second substrate disposed parallel to each other with a predetermined interval; a plurality of protrusions formed on the first substrate at positions corresponding to the lens regions and separated from each other; a first electrode formed over the surface of the first substrate and covering the protrusions; at least one second electrode formed on the surface of the second substrate, which are located in the non-lens regions, wherein the region between two adjacent second electrodes is the lens region; a liquid crystal layer provided between the first and the second substrates and; a voltage source electrically coupled to the first and the second electrodes and respectively applying voltages to the first electrode and the second electrodes for driving liquid crystal molecules.

The display panel is disposed below the layer of the electrically-driven liquid crystal lenses for projecting a 2D image to the layer of the electrically-driven liquid crystal lenses to generate a 3D image.

In the stereoscopic display according to an embodiment of the present invention, the 2D image transforms into the 3D image through the layer of the electrically-driven liquid crystal lens when voltages are applied to the electrically-driven liquid crystal lens. In other words, the 2D image remains as the 2D image through the layer of electrically-driven liquid crystal lens when voltages are turned-off. Therefore, the capability of switching between 3D images and 2D images can be achieved.

In the stereoscopic display according to an embodiment of the present invention, the lens regions are extended as strips along the longitude of the first substrate and each lens region has the same width. The intervals between the lens regions are the same. The protrusions are extended as the strips corresponding to the lens regions and each protrusion has a thickness thereof. Furthermore, the cross-sections of the protrusions are symmetrical or asymmetrical shapes.

The stereoscopic display according to an embodiment of the present invention further includes a first alignment film formed over the entire surface of the first electrode for aligning liquid crystal molecules to be parallel to the surface of the first substrate; and a second alignment film formed over the entire surface of the second electrodes and the second substrate for aligning liquid crystal molecules to be parallel to the surface of the second substrate.

In one preferred embodiment, the first electrode and the second electrodes are composed of transparent conductive materials.

According to the stereoscopic display of the present invention, the layer of the electrically-driven liquid crystal lens employs the above-mentioned electrically-driven liquid crystal lens of the present invention. The shapes of the protrusions induce the fringing fields for guiding the liquid crystal molecules that are near the central region of the lens region to rotate sufficiently. Therefore, the second electrodes can be formed on the inward surface of the second substrate, and such configuration can significantly reduce the driving voltage and power consumption of the electrically-driven liquid crystal lens, and the focus effect is greatly increased to achieve a better 3D image quality.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic diagram illustrating a conventional stereoscopic display technique using a parallax barrier;

FIG. 2 is a schematic diagram illustrating a conventional stereoscopic display technique using a lenticular array;

FIG. 3a is a schematic cross-sectional diagram illustrating a conventional LC lens with an off-load voltage;

FIG. 3b is a graph illustrating a relationship between the refractive indices and the positions of the LC lens with an off-load voltage;

FIG. 4a is a schematic cross-sectional diagram illustrating a conventional LC lens with an on-load voltage;

FIG. 4b is a graph illustrating a relationship between the refractive indices and the positions of the LC lens with an on-load voltage;

FIG. 5a is a schematic cross-sectional diagram illustrating a conventionally improved LC lens with an on-load voltage;

FIG. 5b is a graph illustrating a relationship between the refractive indices of incident lights and the positions of the improved LC lens with an on-load voltage;

FIG. 6a is a schematic cross-sectional diagram illustrating the electrically-driven liquid crystal lens with an off-load voltage according to one preferred embodiment of the present invention;

FIG. 6b is a graph illustrating a relationship between the refractive indices of incident light and the positions of the electrically-driven liquid crystal lens with an off-load voltage according to one preferred embodiment of the present invention;

FIG. 7a is a schematic cross-sectional diagram illustrating the electrically-driven liquid crystal lens with an on-load voltage according to one preferred embodiment of the present invention;

FIG. 7b is a graph illustrating a relationship between the refractive indices of incident light and the positions of the electrically-driven liquid crystal lens with an on-load voltage according to one preferred embodiment of the present invention; and

FIG. 8 is a schematic cross-sectional diagram illustrating the stereoscopic display of the preferred embodiment of the present invention.

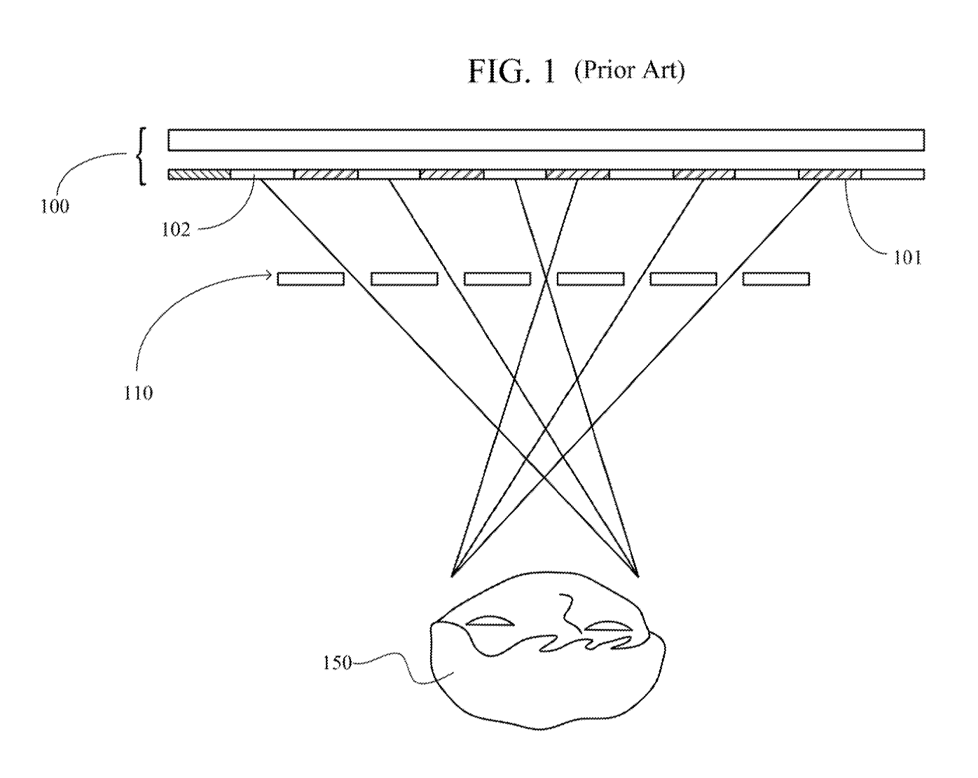

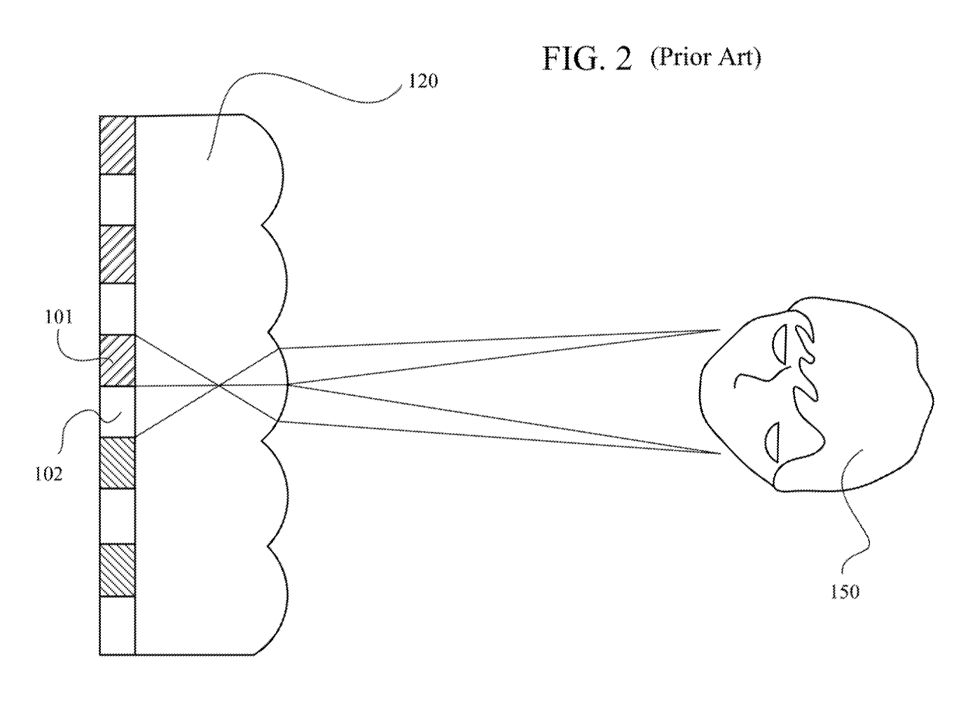

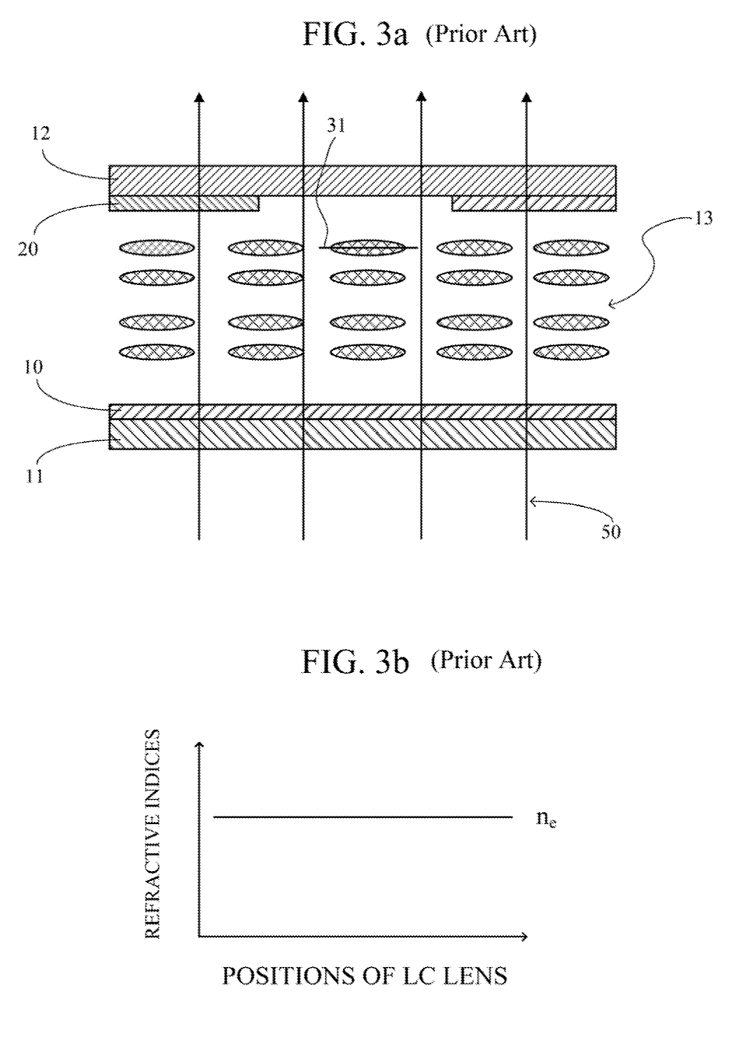

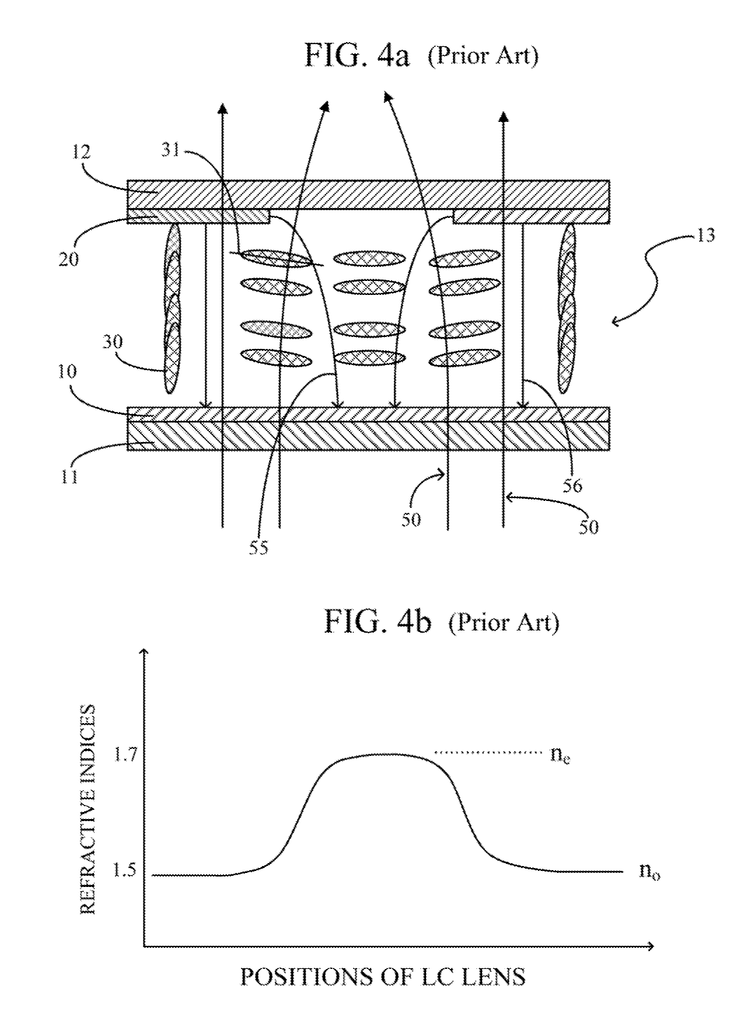

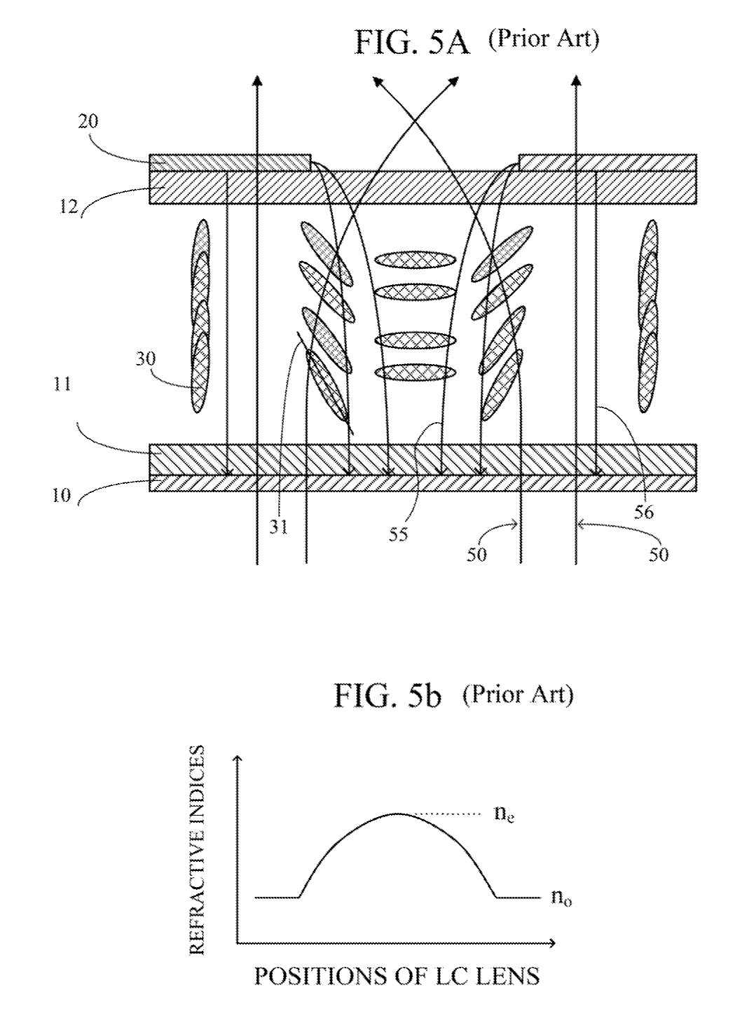

### DETAILED DESCRIPTION OF THE INVENTION

The present invention will now be described in detail with reference to a few preferred embodiments thereof as illustrated in the accompanying drawings. In different drawings, the same reference numbers will be used throughout the drawings to refer to the same or like parts.

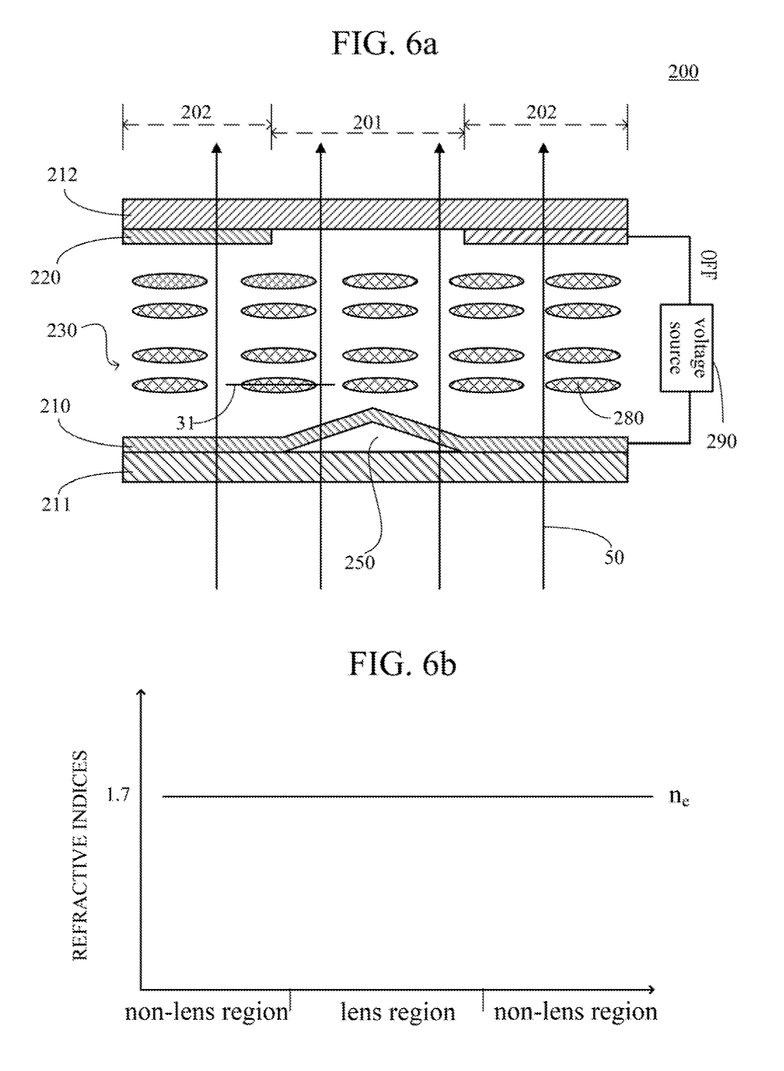

FIG. 6a is a schematic cross-sectional diagram illustrating the electrically-driven liquid crystal lens with an off-load voltage according to one preferred embodiment of the present invention. FIG. 6b is a graph illustrating a relationship between the refractive indices and the positions of the electrically-driven liquid crystal lens with an off-load voltage according to one preferred embodiment of the present invention. Please refer to FIG. 6a, an electrically-driven liquid crystal lens 200 is partitioned into a lens region 201 and a non-lens region 202. Further, the shape of the lens region 201, which is observed from the direction of incident light 50, is a circle or a square, and a preferred shape is a circle. In addition, the non-lens region 202 is the remainder region of the lens region 201 subtracted from the area of the electrically-driven liquid crystal lens 200. The electrically-driven liquid crystal lens 200 includes a first substrate 211, a second substrate 212, a protrusion 250, a first electrode 210, a second electrode 220, a liquid crystal layer 230 and a voltage source 290.

The first substrate 211 and the second substrate 212 are disposed parallel to each other with a predetermined interval, which the present invention does not restrict the distance of the predetermined interval, but its preferred distance is between 30 to 100 microns (μm). Furthermore, these substrates are transparent substrates, and the material of these substrates could be quartz, glass or plastic.

The protrusion 250 is formed on the first substrate 211 at a position corresponding to the lens region 201, that is, the position of the protrusion 250 is located on the central region of the lens region 201. It should be noted that the protrusion 250 in FIG. 6a is an ideal configuration. In fact, the protrusion 250 will be formed with a smooth structure in actually production process.

The first electrode 210 is formed over the entire inward surface of the first substrate 211 and covered the protrusion 250, wherein the inward surface is the inside face between the first substrate 211 and the second substrate 212.

The second electrode 220 is formed on a portion of the surface of the second substrate 212, which is located in the non-lens region 202. The liquid crystal layer 230 is provided between the first substrate 211 and the second substrate 212. The voltage source 290 is electrically connected to the first electrode 210 and second electrode 220, wherein the voltage source 290 respectively applies voltages to the first electrode 210 and second electrode 220 for driving liquid crystal molecules 280 to rotate.

In the electrically-driven liquid crystal lens 200 according to one preferred embodiment of the present invent, the second electrode 220 can be formed on the inward surface of the second substrate 212 and adjacent to the liquid crystal layer 230 or formed on the outward surface of the second substrate 212, and it is preferred that the second electrode 220 can be formed on the inward surface of the second substrate 212 as shown in FIG. 6a.

Please refer to FIG. 6a. While the voltage source 290 is at closed (OFF) status, there is no voltage difference applied to the first electrode 210 and second electrode 220 resulting in no electric field generated within the liquid crystal layer 230. Meanwhile, the guide axes 31 of the liquid crystal molecules 280 within the liquid crystal layer 230 along the alignment layer (not shown) are parallel to the two substrates 211 and 212.

Please refer to FIG. 6b. Meanwhile, the refractive indices, which the incident light 50 senses, does not change with different incident regions such as the lens region 201 or non-lens region 202. Moreover, the refractive indices thereof are an extraordinary index nₑ, which the value is 1.7, and there is no focus effect in the incident light 50 which is perpendicular to the first substrate 211.

Please refer to FIG. 6a. The electrically-driven liquid crystal lens 200 according to one preferred embodiment of the present invention further includes a first alignment film (not shown) formed over the entire surface of the first electrode 210 and the protrusion 250 for aligning liquid crystals molecules 280 to be parallel to the surface of the first substrate 211; and a second alignment film (not shown) formed over the entire surface of the second electrode 220 and the second substrate 212 for aligning the guide axes 31 of the liquid crystal molecules 280 to be parallel to the surface of the second substrate 212.

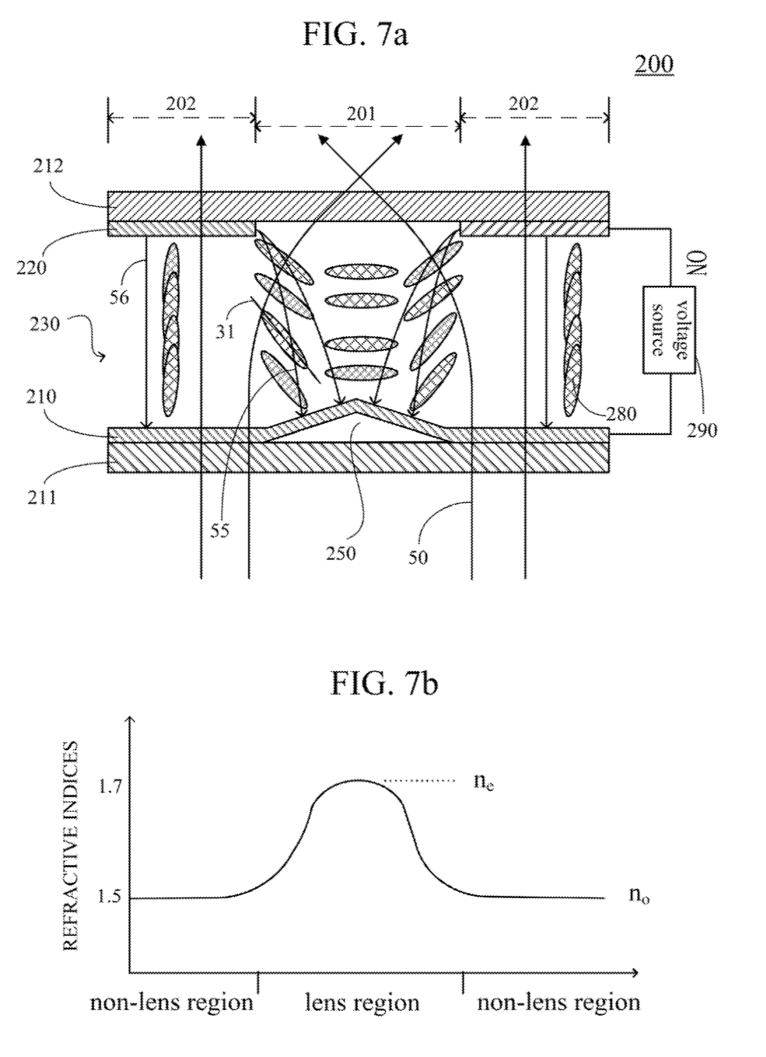

FIG. 7a is a schematic cross-sectional diagram illustrating the electrically-driven liquid crystal lens with an on-load voltage according to one preferred embodiment of the present invention. FIG. 7b is a graph illustrating a relationship between the refractive indices and the positions of the electrically-driven liquid crystal lens with an on-load voltage according to one preferred embodiment of the present invention.

Please refer to FIG. 7a. While the voltage source 290 is at open (ON) status, there is a voltage difference applied to the first electrode 210 and second electrode 220 resulting in the fringing fields 55 generated within the lens region 201 of the liquid crystal layer 230. Meanwhile, the fringing fields 55 point towards the surface of the first electrode 210 which is on the protrusion 250, and the steep fringing fields 55 are formed within the liquid crystal layer 230 for driving the guide axes 31 of the liquid crystal molecules 280 rotating along the direction of the fringing fields 55. The angles of rotations increase from the center to the edge of the lens region 201. The liquid crystal molecules 280 within the non-lens region 202 are arranged along the direction of the electric field 56 with perpendicular to the first substrate 211 or the second 212.

Please refer to FIG. 7b. While the incident light 50 incidents perpendicularly to the first substrate 211, the refractive indices, which the incident light 50 senses, change with different incident positions. The center of the lens region 201 within the liquid crystal layer 230 is scarcely affected by the fringing fields 55. The guide axes 31 of the liquid crystal molecules 280 herein are parallel to the first substrate 211 or the second substrate 212. The refractive index at the central region, which the incident light 50 senses, is an extraordinary index ne, which the value is 1.7. However, in the non-lens region 202, the direction of the electric field 56 is perpendicular to the first substrate 211, and the guide axes 31 of the liquid crystal molecules 280 rotate perpendicularly to the first substrate 211. The refractive indices at the non-lens region 202, which the incident light 50 senses, are an ordinary index nₒ, which the value is 1.5. As the surface shape of the protrusion 250 induces the distribution of the fringing fields 55, the liquid crystal molecules 280 at the lens region generate a gradient change of the refractive indices with the incidence positions. The gradient of the refractive indices relatively changes smoothly and more consistent with the distribution of the GRIN lens, and can generate a better light focus effect.

In addition, since the first electrode 210 and the second electrode 220 are formed on the inward surfaces of the first substrate 211 and the second substrate 212 according to the embodiment of the present invent, the distance between the first electrode 210 and second electrode 220, which is related to that the electrodes are formed on the outer surface, is significantly reduced for improving the shortcoming which the driving voltage of the conventional technique requires about 150V. It is worth mentioning that the driving voltage in the electrically-driven liquid crystal lens of one preferred embodiment is only 4V to 8V.

According to the electrically-driven liquid crystal lens 200 of one preferred embodiment of the present invent, the protrusion 250 has a thickness thereof, and the shapes of the protrusions 250 are designed according to the shapes of the lens region 201. Furthermore, the cross-section of the protrusion 250 is a bilaterally symmetrical shape or asymmetrical shape which can be designed according to characteristics of liquid crystal molecules, e.g., considering the pre-tilt angle of liquid crystal molecules to design an asymmetrical shape. Furthermore, the thickness and width of the symmetrical or asymmetrical shape are between 2 μm to 20 μm, wherein the symmetrical or asymmetrical shape is a geometrical shape such as triangle, trapezoid, semicircle or bell.

The method for fabricating the protrusion 250 includes fabricating a predetermined photoresist bump on the first substrate by photolithography; and depositing a conductively transparent material on the bump and the entire surface of the first substrate 211 to form the first electrode 210 and the protrusion 250.

In the electrically-driven liquid crystal lens 200 according to one preferred embodiment of the present invent, the first electrode 210 and the second electrode 220 are composed of transparent conductively materials such as Indium Tin Oxide (ITO) or Indium Zinc Oxide (IZO).

As described above, the electrically-driven liquid crystal lens 200 according to the present invention utilizes the shapes of the protrusion 250 to guide the fringing fields 55, and increasingly makes the liquid crystal molecules that are near the central region of the lens region 201 to rotate. Therefore, the second electrode 220 can be formed on the inward surface of the second substrate 212, and such configuration can substantially reduce the driving voltage to 4V-8V, and the focus effect is also greatly increased. Furthermore, as the effect of the protrusion 250 guiding the fringing fields 55, the shortcoming which the liquid crystal molecules at the central region of the liquid crystal lens with a wide range are scarcely driven by the fringing fields 55 is also resolved.

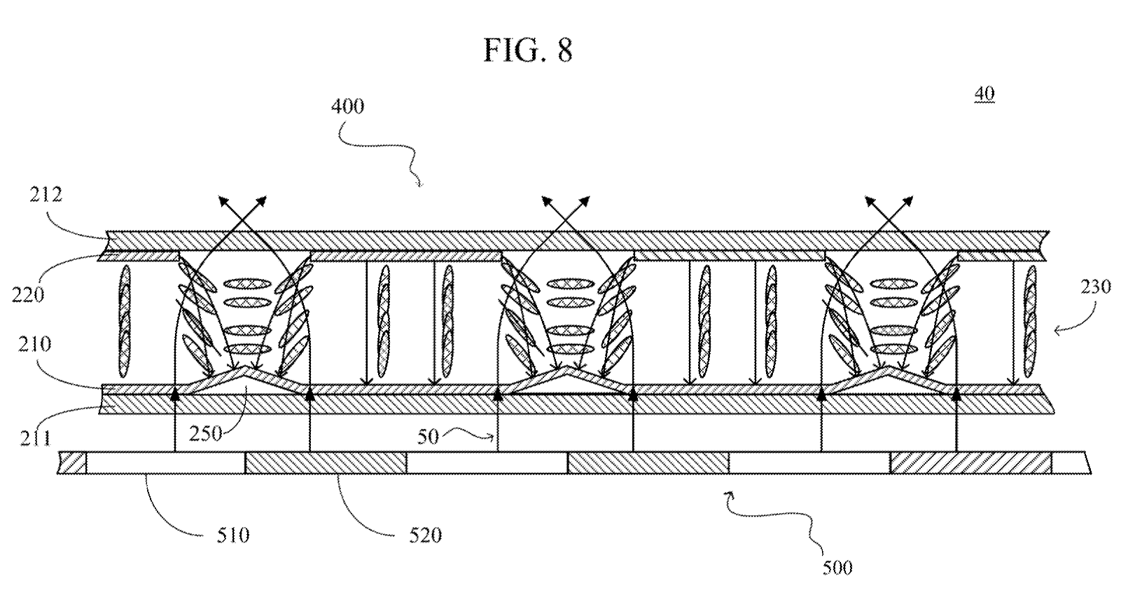

FIG. 8 is a schematic cross-sectional diagram illustrating the stereoscopic display of the preferred embodiment of the present invention. Please refer to FIG. 8. The present invention also provides a stereoscopic display 40, which includes a layer of electrically-driven liquid crystal lens 400 and a display panel 500. It should be noted that the layer of electrically-driven liquid crystal lens 400 is composed of the plurality of electrically-driven liquid crystal lenses 200. Those concepts and details are the same as aforementioned, and it is unnecessary to go into details. Its figures and the reference numbers can be referred to FIG. 6a or FIG. 7a.

Please refer to FIG. 7a and FIG. 8. The layer of electrically-driven liquid crystal lens 400 is partitioned into a plurality of lens regions 201 and at least one non-lens region 202 which the lens regions 201 and the non-lens regions 202 interlace with one another. The layer of electrically-driven liquid crystal lens 400 includes: a first substrate 211 and a second substrate 212 disposed parallel to each other with a predetermined interval; a plurality of protrusions 250 formed on the first substrate 211 at positions corresponding to the lens regions 201 and separated from each other; a first electrode 210 formed over the entire surface of the first substrate 211 and covering the protrusions 250; at least one second electrode 220 formed on the surface of the second substrate 212, which are located in the non-lens regions 202, wherein the region between two adjacent second electrodes 220 is the lens region 201; a liquid crystal layer 230 provided between the first and the second substrates 211,212; and a voltage source 290 electrically coupled to the first and the second electrodes 210,220 and applying voltages to the first electrode 210 and the second electrodes 220 respectively for driving liquid crystal molecules to rotate.

The display panel 500 is disposed below the layer of electrically-driven liquid crystal lens 400 for projecting a 2D image to the layer of electrically-driven liquid crystal lens 400 to generate a 3D image.

The display panel 500 includes a plurality of pixels of left eye images 510 and a plurality of pixels of right eye images 520 which respectively correspond to the electrically-driven liquid crystal lenses 200 within the layer of electrically-driven liquid crystal lens 400. Furthermore, the pixels of left eye images 510 are focused and projected to left eye of an observer, and the pixels of right eye images 520 are focused and projected to right eye of an observer for generating the 3D images.

In the stereoscopic display 40 according to an embodiment of the present invention, the 2D image transforms into the 3D image through the layer of the electrically-driven liquid crystal lens 400 when the voltage Source 290 applies voltages to the electrically-driven liquid crystal lens. In other words, the 2D image remains as the 2D image through the layer of electrically-driven liquid crystal lens when the voltage source 290 is turned-off. Therefore, the capability of switching between 3D images and 2D images can be achieved.

In the stereoscopic display 40 according to an embodiment of the present invent, the lens regions 201 and the non-lens regions 202 are extended as strips along the longitude of the first substrate and are disposed as interlacing strips in place of parallax barriers or lenticular array. The intervals between the lens regions 201 are the same. Furthermore, the protrusions are extended as the strips corresponding to the lens regions and each protrusion 250 has a thickness thereof. The cross-sections of the protrusions 250 are symmetrical or asymmetrical shapes, wherein the symmetrical or asymmetrical shapes are geometrical shapes such as triangles, trapezoids, semicircles, or bells.

The stereoscopic display 40 of an embodiment of the present invention further includes: a first alignment film (not shown) formed over the entire surface of the first electrode 210 for aligning liquid crystals molecules 280 to be parallel to the surface of the first substrate 211; and a second alignment film (not shown) formed over the entire surface of the second electrodes 220 and the second substrate 212 for aligning liquid crystals molecules to be parallel to the surface of the second substrate 212.

In the stereoscopic display 40 according to an embodiment of the present invent, the first electrode 210 and the second electrodes 220 are composed of transparent conductive materials.

As described above, according to the stereoscopic display 40 of the present invent, the layer of electrically-driven liquid crystal lens 400 employs the aforesaid electrically-driven liquid crystal lenses 200 for guide the fringing fields 55 using the shapes of the protrusion 250, and making the liquid crystal molecules 280 that are near the central region of the lens region 201 rotate increasingly. Therefore, the second electrode 220 can be formed on the inward surface of the second substrate 212, and such configuration can substantially reduce the driving voltage and power consumption of the layer of electrically-driven liquid crystal lens 400 for reducing the cost of driving elements. More importantly, the focus effect can be increased to achieve a better 3D image quality.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An electrically-driven liquid crystal lens, which is partitioned into a lens region and a non-lens region, comprising:
a first substrate;
a second substrate disposed parallel to the first substrate and being separated from the first substrate by a predetermined interval;
a protrusion formed on the first substrate at a position corresponding to the lens region;
a first electrode formed over the inward surface of the first substrate and covering the protrusion;
a second electrode formed on a portion of the surface of the second substrate, which is located in the non-lens region;
a liquid crystal layer provided between the first and the second substrates; and
a voltage source electrically coupled to the first and the second electrodes and applying voltages respectively to the first and the second electrodes for driving liquid crystal molecules.

2. The electrically-driven liquid crystal lens of claim 1, wherein the second electrode is formed on the inward surface of the second substrate.

3. The electrically-driven liquid crystal lens of claim 1, wherein the protrusion has a thickness.

4. The electrically-driven liquid crystal lens of claim 1, wherein the cross-section of the protrusion is of a symmetrical or asymmetrical shape.

5. The electrically-driven liquid crystal lens of claim 4, wherein a height of the symmetrical or asymmetrical shape is between 2 μm to 20 μm.

6. The electrically-driven liquid crystal lens of claim 4, wherein a width of the symmetrical or asymmetrical shape is between 2 μm to 20 μm.

7. The electrically-driven liquid crystal lens of claim 4, wherein the symmetrical or asymmetrical shape is a geometrical shape.

8. The electrically-driven liquid crystal lens of claim 2, further comprising:
a first alignment film formed over the entire surface of the first electrode for aligning liquid crystal molecules to be parallel to the surface of the first substrate; and
a second alignment film formed over the entire surface of the second electrode and the second substrate for aligning liquid crystal molecules to be parallel to the surface of the second substrate.

9. The electrically-driven liquid crystal lens of claim 1, wherein the first electrode and the second electrode are composed of transparent conductive materials.

10. A stereoscopic display, comprising:
a layer of electrically-driven liquid crystal lens partitioned into a plurality of lens regions and at least one non-lens region, wherein the lens regions and the non-lens regions interlace with one another, comprising:
a first substrate and a second substrate disposed parallel to each other with a predetermined interval;
a plurality of protrusions formed on the first substrate at positions corresponding to the lens regions and separated from each other;
a first electrode formed over the inward surface of the first substrate and covering the protrusions;
at least one second electrode formed on the surface of the second substrate, which are located in the non-lens regions, wherein the region between two adjacent second electrodes is the lens region;
a liquid crystal layer provided between the first and the second substrates; and
a voltage source electrically coupled to the first and the second electrodes and applying voltages respectively to the first electrode and the second electrodes for driving liquid crystal molecules; and
a display panel disposed below the layer of the electrically-driven liquid crystal lens for projecting a two-dimensional image to the layer of the electrically-driven liquid crystal lens to generate a three-dimensional image.

11. The stereoscopic display of claim 10, wherein the two-dimensional image transforms into the three-dimensional image through the layer of the electrically-driven liquid crystal lens when voltages are applied to the layer of the electrically-driven liquid crystal lens.

12. The stereoscopic display of claim 10, wherein the two-dimensional image remains as the two-dimensional image through the layer of the electrically-driven liquid crystal lens when voltages are turned-off.

13. The stereoscopic display of claim 10, wherein the lens regions are extended as strips along the longitude of the first substrate and each lens region has the same width.

14. The stereoscopic display of claim 10, wherein the intervals between the lens regions are the same.

15. The stereoscopic display of claim 10, wherein the protrusions are extended as the strips corresponding to the lens regions and each protrusion has a thickness thereof.

16. The stereoscopic display of claim 15, wherein the cross-sections of the protrusions are symmetrical or asymmetrical shapes.

17. The stereoscopic display of claim 16, wherein the symmetrical or asymmetrical shapes are geometrical shapes.

18. The stereoscopic display of claim 10, further comprising:
a first alignment film formed over the entire surface of the first electrode for aligning liquid crystal molecules to be parallel to the surface of the first substrate; and
a second alignment film formed over the entire surface of the second electrodes and the second substrate for aligning liquid crystal molecules to be parallel to the surface of the second substrate.

19. The stereoscopic display of claim 10, wherein the first electrode and the second electrodes are composed of transparent conductive materials.
